(19) United States
(12) Patent Application Publication
(10) Pub. No.: US 2010/0126804 A1
(43) Pub. Date: May 27, 2010

(54) AN ENGINE USING POTENTIAL AND BUOYANCY ENERGY WITH DE PRESSURE TRANSFER BOX

(76) Inventor: Narayana Thevar Sabapathy, Chennai (IN)

Correspondence Address: Ahamed Mohideen;Narayana Thevar Sabapathy, 16/6 First Cross Street, Sterling Road, Nungambakkam, Chennai, 600034, omitted

(21) Appl. No.: 12/063,106

(22) PCT Filed: Jun. 7, 2006
(86) PCT No.: PCT/IN06/00192

§ 371 Date: Feb. 7, 2008

(30) Foreign Application Priority Data
Sep. 23, 2005 (IN) 1354/CHE/2005

(51) Int. Cl. F03G 3/02; F03G 3/00; F03G 7/10

(52) U.S. Cl. 185/32; 60/495; 74/DIG. 9

(57) ABSTRACT

The buoyancy-gravity engine according to the present invention comprises buoyancy gravity rollers (1) which is constructed with specific dimensions and shape so as to perform its function effectively; a buoyancy chamber; a float regulation machine; a gravity machine with at least one wheel (3); a De-Pressure transfer box (9A); an interlinked BG roller (1) transfer mechanism; and a liquid compensator. The BG Roller (1) travels up and down through the buoyancy column and the gravity machine. When the BG roller (1) moves down in the gravity machine at least one wheel (3) of the machine is rotated due to the eccentric weight of the roller (1) in one end of the wheel (3). The roller (1) then slips down from the fingers of the wheel and rolls down to the mouth of the DP transfer box (9A). The roller is then pushed into the buoyancy column, and due to the inherent law of buoyancy, the roller (1) automatically reaches the top of the buoyancy column and again falls into the fingers of the gravity machine. It should be noted that for the entire operation the energy required is very small and almost negligible.

The present invention relates to an engine, which works on the principle of conversion of potential energy into mechanical energy with the aid of buoyancy energy.

In conventional engines the energy required to generate power is substantially high when converted from one form to another, which also results in the loss in energy. It is long been the desire to generate power for any application whilst spending negligible energy.

The present invention provides such an engine wherein for its entire operation, the energy requirement is very small while ensuring successful operation of the engine.

### SUMMARY OF THE INVENTION

The buoyancy-gravity engine according to the present invention comprises buoyancy gravity rollers (BG rollers) which is constructed with specific dimensions and shape so as to perform its function effectively; a buoyancy chamber; a float regulation machine; a gravity machine with at least one wheel; a De-Pressure transfer box (DP transfer box); an interlinked BG roller transfer mechanism; and a liquid compensator.

In this buoyancy-gravity engine (BG engine), the BG Roller travels up and down through the buoyancy column and the gravity machine. This movement is similar to a piston moving up and down in an Internal Combustion Engine. When the BG roller moves down in the gravity machine at least one wheel of the machine is rotated due to the eccentric weight of the roller in one end of the wheel. The roller then slips down automatically from the fingers of the wheel and rolls down to the mouth of the DP transfer box. The BG roller then goes into the DP Transfer box when a valve is opened. The same BG roller then goes up into the buoyancy chamber when another valve is opened. The BG roller in the buoyancy column, due to the inherent law of buoyancy, automatically reaches the top of the buoyancy column and again falls into the fingers of the gravity machine. Thus the gravity machine is continuously made to rotate due to the rollers. It should be noted that for the entire operation the energy required is very small and almost negligible.

### BRIEF DESCRIPTION OF THE DRAWINGS

FIG. 1 shows the schematic drawing of the BG Engine according to this invention,

FIG. 2 shows the construction of the BG Roller,

FIG. 3 shows the construction of the buoyancy chamber,

FIG. 4 shows the construction of the gravity machine,

FIG. 5 shows the construction of the De-Pressure Transfer box,

FIGS. 6a and 6b shows the construction of the Inter linked BG Roller Transfer Mechanism.

FIG. 7 shows the construction of the float regulation machine in the buoyancy column,

### DETAILED DESCRIPTION OF THE INVENTION

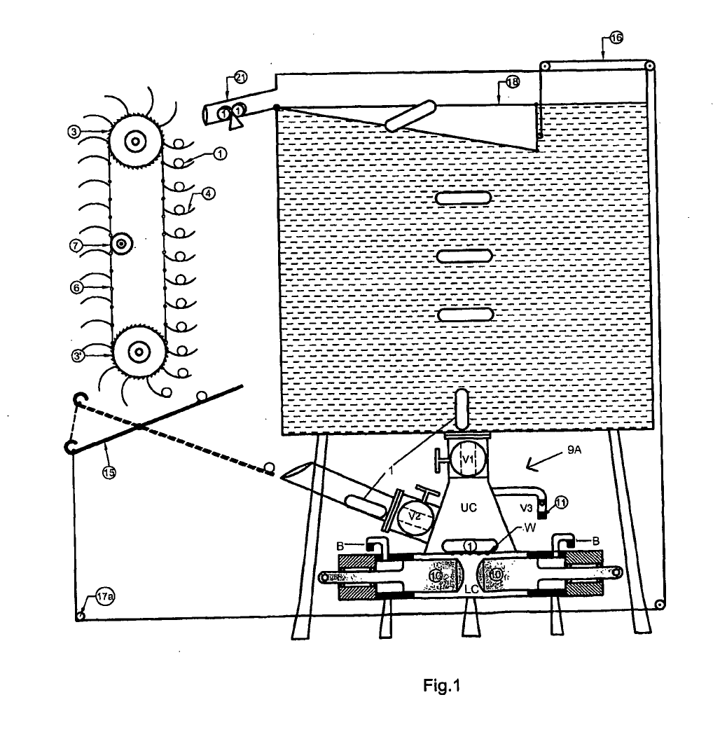

The invention can be best illustrated as seen in FIG. 1. The BG roller (1) (herein referred to as roller) are placed one by one on roller housings which are specially designed fingers (4), and are allowed to travel by its own gravitational force down the gravity machine (100). The gravity machine (100) consists of at least one wheel (3), preferably two wheels connected together by a chain. The fingers (4) are peripherally placed on the wheels (3) to hold the rollers (1). Due to the eccentric weight of the rollers (1) placed on the peripheral of the wheel (3), the wheel (3) begins to rotate. The torque produced in the center of the wheel depends of the weight of the rollers (1), the radial distance from the center of the wheel to the center of the roller, the height from the ground and the angle of force acting on the center of the wheel. The gravity machine represents the downward motion of the piston in an IC engine.

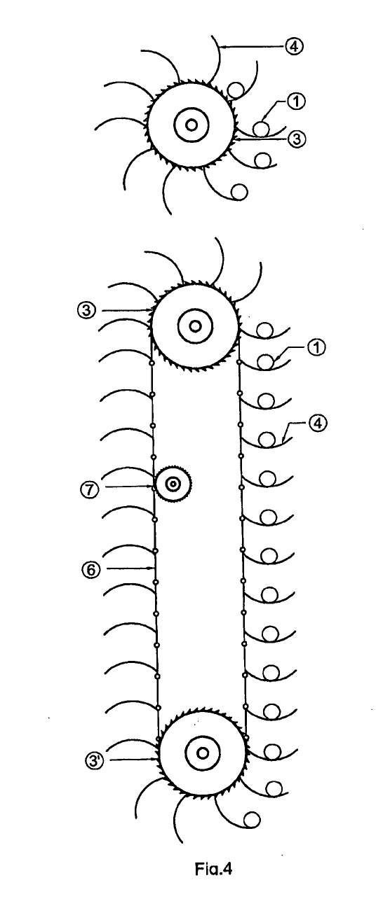

In FIGS. 1 and 4, a gravity machine (100) with more than one wheel (3, 3′) is illustrated. A linkage, preferably a chain (6) connects the wheel (3) with a balancing wheel (3′). The top wheel (3) is the power hub. A third wheel shown is the idler wheel (7) that facilitates the adjustment of the tension in the chain (6). It should be noted that the fingers (4) are fixed with the chain (6). As more number of rollers (1) is placed in the wheel chain, higher torques can be obtained for different applications. Moreover, all the rollers are acting vertically downwards.

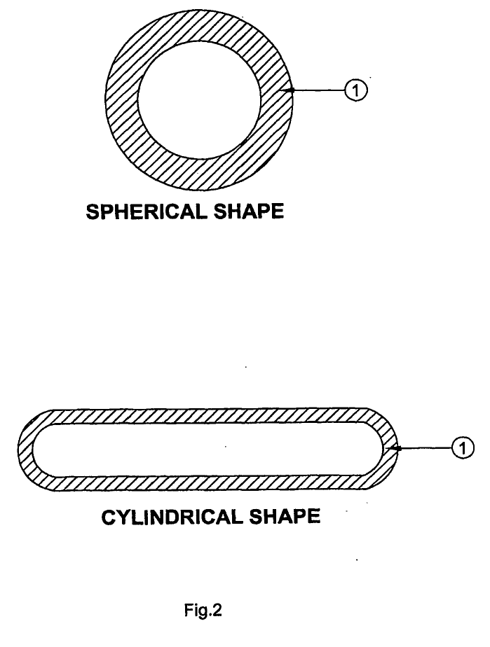

The construction of the rollers is shown in FIG. 2. The BG rollers (1) are preferably made of heavy metals in either spherical or cylindrical shapes. Preferably cylindrical shapes are used in this invention to facilitate easy transfer of the roller (1) into the buoyancy chamber (2). The volume of the roller (1) is such that the roller (1) when immersed in the buoyancy chamber (2) displaces an amount of liquid more than the weight of the roller (1) so that the roller (1) floats as per the buoyancy law. In this BG engine, the rollers (1) acts as piston of an IC engine traveling up and down through the buoyancy column (2) and the gravity machine (100).

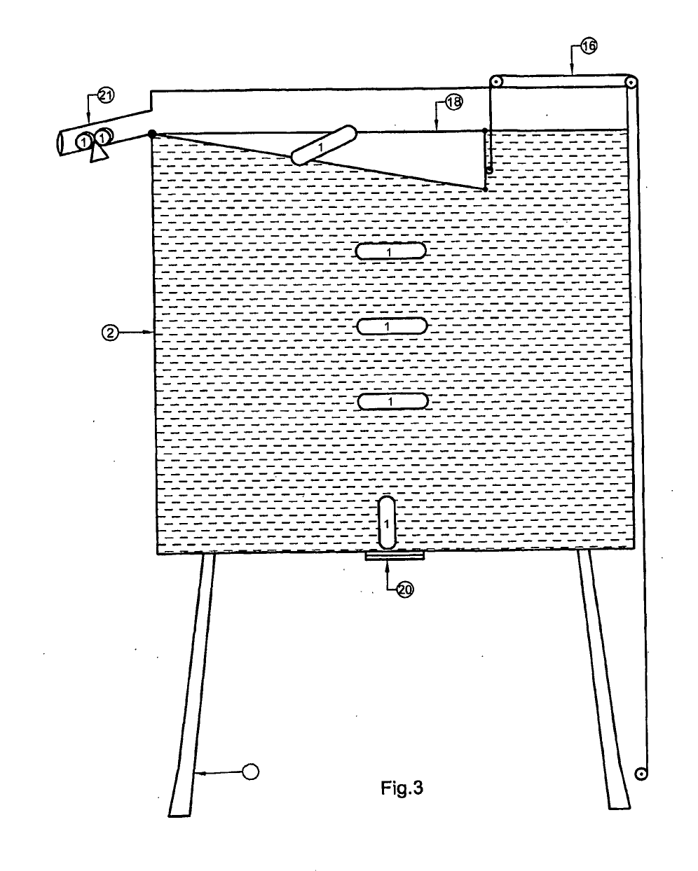

The construction of the buoyancy chamber (2) according to this invention is shown in FIG. 3. The buoyancy chamber (2) is a vertical vessel like chamber made of either heavy metal sheets or concrete or brick structure or any other similar materials. A provision (20) for accommodating the de-pressure transfer box is made below the bottom wall of the buoyancy chamber (2). A tube (21) is provided at the top portion of the buoyancy chamber (2) as illustrated in FIG. 3. The tube (21) aids in smooth transfer of the rollers (1) into the fingers (4) of the gravity machine (100). The buoyancy chamber (2) is provided for the upward movement of the rollers (1) from the bottom of the gravity machine (100) to the top of the gravity machine (100) by spending very little (negligible) energy for the transfer of the rollers (1) into the buoyancy chamber (2).

The crux of the invention lies in the transfer of the rollers (1) from the gravity machine (100) to the buoyancy column (2) and vice versa. For every one roller (1) that is transferred from the bottom of the gravity machine (100) to the bottom of the buoyancy chamber (2), one roller has to be transferred from the top of the buoyancy chamber (2) to the top finger (4) of the gravity machine (100). This is essential for the maintaining the water level in the correct position in the buoyancy chamber (2) and for the continuous functioning of the engine and for production of continuous power output from the power hub. Such a mechanism requires precise timing in the transfer of the rollers (1).

The de-pressure transfer box (9A) and the interlinked BG roller transfer mechanism (9B) according to this invention facilitates in accurate timing in transfer of the rollers (1) from the gravity machine (100) to the buoyancy chamber (2) and vice versa.

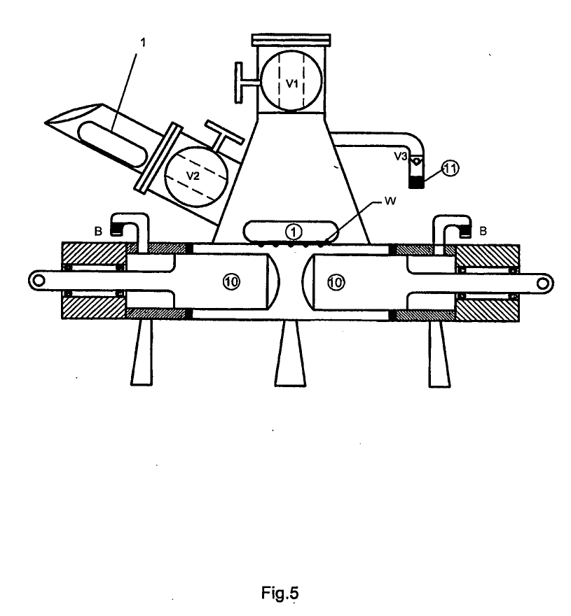

FIG. 5 shows the construction of the de-pressure transfer box (DP transfer box) (9A). The DP transfer box (9A) is made mostly of metal sheets or plates. This transfer box (9A) consists of an upper chamber (UC) and lower chamber (LC) having interlinked passage for the movement of water from one to the other. The upper chamber (UC) of the DP transfer box (9A) comprises three valves (V1, V2, and V3). The bottom of the upper chamber (UC) has an open space provided with a weld mesh (W) to hold the roller in the upper chamber (UC) and at the same time permits the flow of water in between the upper and lower chambers of the transfer box freely. Valve V1 permits the roller (1) to go into the buoyancy chamber (2) without any obstruction. This valve may be of ball type, taper roller type, flat type, cylindrical type etc. This valve V1 is fixed in between bottom of the buoyancy column and top of the roller holding box. The main functions of this valve are (i) to permit the roller into the buoyancy column smoothly from the transfer box; (ii) to cut off the high pressure of the buoyancy column in the transfer box and thereby permits the smooth flow of the roller into the transfer box.

Valve V2 is constructionally the same as V1 and is fixed in an inclined position between roller sliding/rolling inclined plane of the gravity machine and the roller holding box of the transfer box (9A). The main function of this valve is to permit the roller (1) to slide from the gravity machine (100) into the DP transfer box (9A) and to arrest the water leakage when valve V1 is opened. The operation of valves V1, V2 can be of cam, gear, lever or any other mechanism, which are interlinked with timings.

The valve V3, which is a one-way valve, is fixed in the highest place on one side of the upper chamber (UC) of the transfer box (9A). This valve works automatically and requires no special arrangement for operation. The function of the valve V3 is to equalize the pressure drop (vacuum) inside the DP transfer box (9A) created due to the withdrawal/outward movement of the pistons (10), by permitting air into the transfer box automatically and at the same time not permitting water going out of the transfer box (9A). A filter (11) is provided in valve V3 (one way valve) to prevent entry of dust and foreign particles/objects from passing into V3.

The lower chamber (LC) of the transfer box (9A) is preferably cylindrical shape though not restricted to any shape and is provided to hold the piston assemblies. The pistons (10) are moveable inwards and outwards in order to provide smooth entry of the roller into the upper chamber (UC) and helps in the passing of the roller (1) into the buoyancy chamber smoothly. Breathers (B) are provided for smooth travel of pistons (10).

The pistons (10) do not develop any pressure in the water column. They only occupy the space in the buoyancy column. The pistons (10) are designed to occupy the space of about 5 to 10% (as per design requirements) more than the volume of the roller, so that the roller (1) can enter the upper chamber (UC) without any objection by the water available in the transfer box (9A). The movement of the pistons (10) can be operated by cam, gear or any other mechanism.

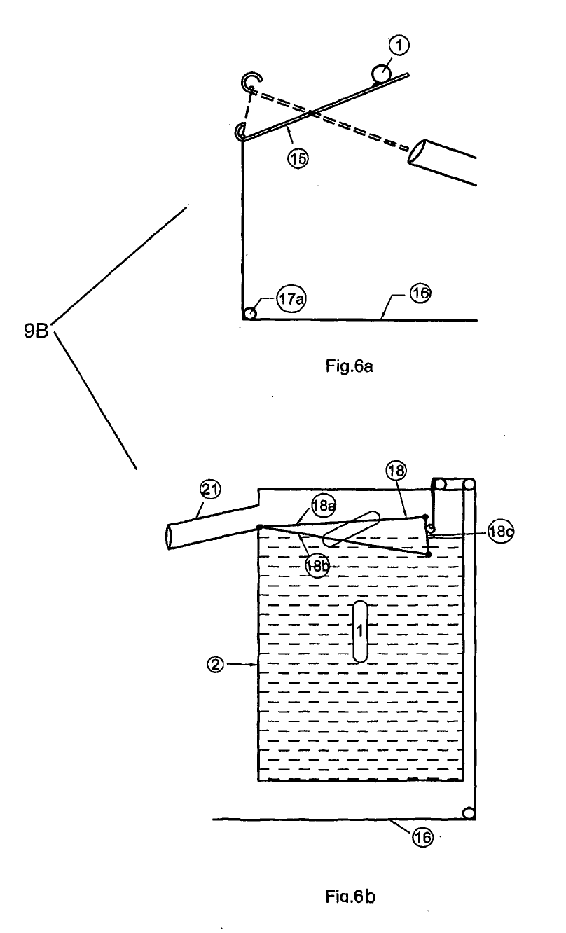

FIGS. 6a and 6b illustrate the interlinked BG roller transfer mechanism (9B). This mechanism facilitates the continuous functioning of the engine by transferring the rollers (1) mutually from the gravity engine (100) to the buoyancy chamber (2) and vice versa. This mechanism (9B) comprises a long pedal (15) anchored at its center or away from its center of leverage. On one end of the pedal (15) a long rope (16) is tied and the other end of the pedal (15) is free to receive the dropped BG roller (1) from the gravity machine (100). When the roller (1) drops onto the free end of the pedal (15), due to the weight of the roller (1), the pedal (15) moves down and thereby pulls the rope (16) tied along the other end of the pedal (15). The other end of the rope (16) is tied with a floating linkage unit (18) provided at the top of the buoyancy chamber though means of a pulley (17B). The linkage is preferably V-shaped links consisting of two rods (18A and 18B) joined, preferably welded, in a V-shape or any other workable shape. The bottom of this V-shaped link is hinged to the side wall of the buoyancy chamber (2) as shown in FIG. 6b. An interconnecting rod (18C) connects the two rods (18a and 18B). The other end of the rope (16) is tied to the center of the interconnecting rod (18C). When one roller (1) falls in the bottom of the gravity machine (100) to the pedal (15) the rope (16) is pulled and the V-link (18) is lifted to one side, making the roller (1) which is floating in the liquid column of the buoyancy chamber (2) to slide and roll out of the buoyancy chamber (2) onto the fingers (4) of the gravity machine (100).

During the operation of the BG engine, the liquid level in the buoyancy chamber (2) may reduce due to the transfer of rollers and spillage. In order to maintain the proper level in the buoyancy chamber, a liquid compensator tank is disposed on the top of the buoyancy chamber (2) with filling arrangement.

To begin operation of the BG engine, the pistons (10) of the De-Pressure Transfer Box (9A) are in a closed position, the BG roller (1) is either gently pushed or freely falls due to gravity inside the DP transfer box (9A) while the valve V2 is in the open position. Once the roller (1) is inside the DP transfer box (9A), the valve V2 is closed. The valve V1 in the DP transfer box (9A) is now opened. Immediately the water from the buoyancy chamber (2) rushes into the transfer box (9A) and fills up the space of the transfer box (9A). The pressure in the buoyancy chamber (2) and the DP transfer box (9A) are now equal. Now the roller (1) in the transfer box (9A) begins to float and moves up due to the buoyancy effect and the roller (1) reaches the top of the buoyancy chamber (2) without any external effort and, due to the construction of the roller as described with reference to FIG. 2, is capable of floating in the liquid column. Then, the valve V1 returns to the closed position and the buoyancy column (2) is cut off from the transfer box (9A) and thereby the pressure in the transfer box (9A) becomes negligible. Now the pistons (10) are moved away from each other. This action creates vacuum in the transfer box (9A). At the same time the water in the transfer box (9A) comes down to the lower chamber (LC) due to the outward movement of the pistons (10). Breathers (B) are provided for equalizing the pressure due to the inward and outward movement of the pistons (10). A non-return valve V3 is provided in this transfer box (9A) that helps to equalize the vacuum created by the action of the pistons by permitting air into the transfer box (9A). Once equilibrium is established inside the DP transfer box (9A), the valve V3 returns to its closed position. The upper chamber (UC) of the transfer box (9A) is empty to receive the next roller (1) and the lower chamber (LC) is filled with water due to the return movement of the pistons (10).

The roller (1) floating on the top surface of the liquid column of the buoyancy chamber (2) is now pushed onto the fingers (4) of the gravity machine (100) by the action of the V linkages. Due to eccentric weights acting on the one side of the wheel (3), the wheel (3) begins to rotate. This rotation of the wheel allows the finger (4) containing the roller (1) to travel longitudinally downwards. When the roller approaches the bottom of the gravity machine (100), it slips off automatically from the fingers (4) and proceeds to move into the mouth of the DP transfer box (9A) and is now ready for the next cycle of operation.

Now the valve V2 is opened and the roller (1) that is being dropped from the gravity machine (100) is immediately rolled/slid into the upper chamber (UC) of the transfer box (9A) through valve V2. The pistons (10) are now moved inwards. The pistons (10) occupy the area in the lower chamber (LC) and naturally the water has to move to the upper chamber (UC) of the transfer box. Simultaneously valve V2 is closed and now valve V1 is opened. Immediately due to buoyancy effect on the roller (1), it floats and moves up from the transfer box (9A) into the buoyancy column (2) through the valve V1 and reaches the top of the buoyancy column (2). Now the valve V1 is closed and the buoyancy column (2) is cut off from the transfer box (9A) and makes the pressure in the transfer box (9A) negligible. The floating roller (1) in the top of the buoyancy column (2) is gently pushed from the buoyancy column (2) into the top fingers (4) of the gravity machine (100) with the help of the roller transfer mechanism (9B). The roller transfer mechanism (9B) from the top of the buoyancy column (2) to the top of the gravity machine (100) is synchronized such that when one roller (1) goes out of the buoyancy column (2), one roller enters into the bottom of the buoyancy column (2) from the transfer box, so that the spillage water from the buoyancy column (2) is minimum.

The roller (1), which has great potential energy due to its position from the ground, when it reaches the fingers of the gravity machine (100) comes down along with the fingers due to gravity effect, falls down automatically from the fingers of the gravity machine (100) and reaches valve V2 of the transfer box. The roller while coming down due to the gravity rotates the power hub that is linked with a chain (not shown). Thus the potential energy of the roller is utilized for rotating the power hub, i.e. the potential energy of the roller due to its position from the ground is being converted into mechanical energy (rotation of power hub) with the help of buoyancy energy and high torque is available on the power hub for any suitable application.

This cycle of operation repeats itself over and over again. The pistons, valves V1, V2 can be run by operated cams, gear or any other method which consumes minimum power. It is of utmost importance to note that the roller has been lifted to a certain height without spending energy, or at the most a negligible amount of energy.

The synchronization of the movements of all the components of the engine is achieved with the help of the interlinked BG roller transfer mechanism (FIGS. 6a & 6b).

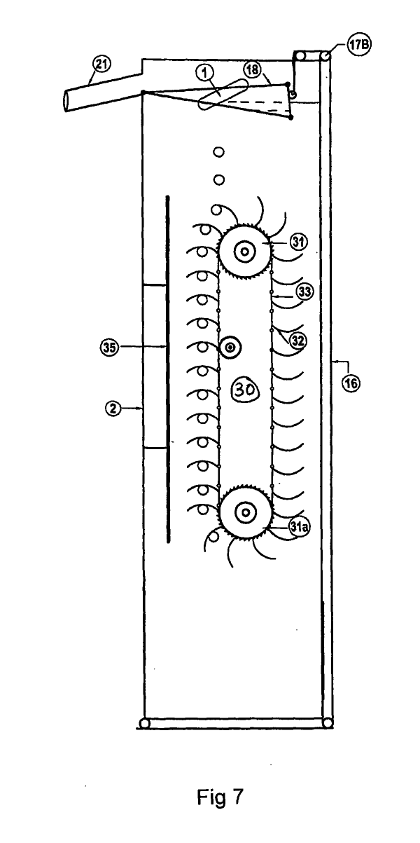

A float regulating means (30) is provided inside the buoyancy chamber to facilitate the synchronous movement of the rollers from the bottom to the top of the liquid column. During the operation of this engine, when the rollers travel longitudinally upward in the liquid column, they hit against one another in a random manner. In order to avoid the hitting of the rollers (1) against one another, as shown in FIG. 7, a means (30) for regulating the float is provided inside the buoyancy chamber. This float regulating means (30) is similar in construction to the gravity machine. The float regulating means (30) comprises a plurality of wheels (31, 31a), wherein one of the wheels is a power hub. The rollers (1) are designed, for instance, that it displaces liquid weighing twice that of the roller (1). Therefore, the float regulating means (30) produces high torque similar to the gravity machine apart from regulating the floating of the BG rollers. Due to the buoyancy force developed in the liquid column, the rollers that are pushed into the buoyancy chamber are automatically attached onto the fingers (32) provided peripherally on the chain (33) that connects the wheels (31, 31a). This mechanism enables the rollers (1) to move from the bottom to the top of the buoyancy column at proper intervals and in a synchronized manner without clashing against each other. Guide plates (35) are provided to ensure that the rollers go into the fingers (32) of the float regulating means (30).

1. An engine comprising a gravity machine having at least one wheel, a buoyancy chamber containing a liquid column, a plurality of rollers provided to travel longitudinally upward in the buoyancy chamber and longitudinally downward in the gravity machine, means (4) to house the rollers provided on the periphery of the wheel; wherein a means (9A) for transferring the roller from the gravity machine to the liquid column is securely connected to the buoyancy chamber and a transfer mechanism (9B) for transferring the rollers from the buoyancy chamber to the means to house the rollers in the gravity machine is provided.

2. The engine as claimed in claim 1, wherein the said means for transferring the roller from the gravity machine to the liquid column comprises pistons and a plurality of valves adapted to push the roller longitudinally upward into the buoyancy chamber due to the effect of buoyancy in the liquid column.

3. The engine as claimed in claim 1, wherein the transfer mechanism comprises a pedal anchored at its center, a first end of a rope attached to a first end of the pedal and a second end of the pedal is adapted to receive the freely falling roller from the gravity machine due to the rotation of the said gravity machine, the second end of the rope is wound on a pulley in close proximity to the top surface of the buoyancy chamber.

4. The engine as claimed in claim 3, wherein the said second end of the rope is connected to a linkage unit provided at the top of the buoyancy chamber.

5. The engine as claimed in claim 4, wherein the linkage unit comprises two rods joined, preferably in a V-shape and an interconnecting rod connecting the free ends of the said two rods, said second end of the rope being connected to the center of the said interconnecting rod.

6. The engine as claimed in claim 1, wherein the said gravity machine has a plurality of wheels, the first wheel and the second wheel being connected by means of a linkage, said means to house the rollers being attached to the said linkage; a third wheel is provided as an idler wheel to facilitate adjustment of the tension in the linkage.

7. The engine as claimed in claim 6 wherein the said linkage is preferably a chain.

8. The engine as claimed in claim 1, wherein the rollers are spherical or cylindrical in shape and are preferably hollow such that the rollers displace more liquid from the liquid column than its weight and floats in the said liquid column as per buoyancy law.

9. The engine as claimed in claim 2, wherein at least one of the plurality of valves is a one-way valve.

10. The engine as claimed in claim 9, wherein a filter is provided in the one-way valve to prevent dust and foreign particles to enter into the buoyancy column.

11. The engine as claimed in claim 1, wherein a liquid compensating tank is provided adjacent to the buoyancy chamber to maintain proper level of the liquid in the liquid column.

12. The engine as claimed in claim 1, wherein a float regulation means is provided inside the buoyancy chamber to enable synchronous movement of the rollers (1) from the bottom of the liquid column to its top.

13. The engine as claimed in claim 12, wherein the float regulating means comprises two wheels connected to each other by connecting means, preferably a chain; a plurality of fingers arranged on the peripheral of the chain to house the roller pushed into the buoyancy chamber and to lift the roller to the top of the liquid column.

14. The engine as claimed in claims 13, wherein a guide plate is provided adjacent to the float regulating means to ensure proper and safe housing of the rollers inside the fingers.

15. A method of generating torque by the engine as claimed in any one of the preceding claims comprising the steps of:
pushing the roller into the transfer box while valve V2 is in the open condition;
closing the valve V2 after the roller enters the transfer box;
permitting the roller into the buoyancy chamber by opening the valve V1, such that the roller travels longitudinally upward in the liquid column of the buoyancy chamber, the said roller is capable of floating in the liquid column due to the effect of buoyancy;
closing the valve V1 after the roller goes into the buoyancy chamber;
moving the piston to its open position and opening the one way valve V3 to allow air to enter into the transfer box to compensate pressure loss due to the outward movement of the pistons;
pushing the roller from the top of the liquid column onto the fingers of the gravity machine by the action of a linkage which allows the roller to freely travel longitudinally downward due to gravity and is in a position to enter the transfer box;
repeating the above process continually such that when one roller is transferred from the buoyancy chamber to the gravity machine, one roller is transferred from the gravity machine to the buoyancy machine in order to maintain the water level and generate continuous torque.

16. The method as claimed in claim 15, wherein the roller drops from the gravity machine onto the second end of the pedal, the weight of the roller causes the pedal to move down and thereby entering the mouth of the transfer box and simultaneously pulling the rope tied along the first end of the pedal.

17. The method as claimed in claim 16, wherein when the rope tied to the first end of the pedal is pulled, the V-shaped linkage provided in the top of the buoyancy chamber is lifted to one side thereby making the floating roller to slide out of the buoyancy chamber into the fingers of the gravity machine.
